(19) United States
(12) Patent Application Publication
(10) Pub. No.: US 2006/0071363 A1
(43) Pub. Date: Apr. 6, 2006

(54) Belt type continuous plate manufacturing device and method of manufacturing sheet polymer

(75) Inventors: Hajime Okutsu, Hiroshima (JP); Hirotoshi Mizota, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Rayon Co., Ltd, Tokyo (JP)

(21) Appl. No.: 10/541,155

(22) PCT Filed: Dec. 22, 2003
(86) PCT No.: PCT/JP03/16446

§ 371 Date: Jun. 30, 2005

(30) Foreign Application Priority Data
Jan. 7, 2003 (JP) 2003-000915
Feb. 6, 2003 (JP) 2003-029367
Feb. 7, 2003 (JP) 2003-036672

(51) Int. Cl. B29D 7/00

(52) U.S. Cl. 264/216; 264/409; 425/371

(57) ABSTRACT

A belt type continuous plate manufacturing apparatus comprising two facing endless belts 1, 1′ and gaskets 7 sandwiched by belt surfaces at their both side edge portions, wherein a polymerizable raw material is fed into a space surrounded by the facing belt surfaces and the gaskets 7 from its one end, the polymerizable raw material is solidified together with running of the belts in a heating zone, and the plate polymer is taken out from the other end, characterized in that three or more upper and lower roll pairs satisfying the following formulae (1) and (2) are placed so that respective axes thereof orthogonally cross the belt running direction, between a raw material feeding position and a heating initiation position; and a method of producing a plate polymer by using it: D/Z≧0.04 (1), 0.30≦D/X≦0.99 (2) [D=outermost diameter of roll body portion (mm), Z=width of roll body portion (mm), X=distance between axis centers of adjacent upper and lower roll pairs (mm)].

### TECHNICAL FIELD

The present invention relates to a belt type continuous plate manufacturing apparatus of producing a plate product (i.e., plate polymer) by continuously polymerizing a polymerizable raw material, and a method of producing a plate polymer using this apparatus.

### BACKGROUND ART

Plate polymers obtained from methyl methacrylate as the main raw material are used in signboard and building material applications, sanitary application such as baths and the like, illumination application, and other wider fields, utilizing their excellent properties. Recently, they are used as a light transmission plate of displays such as liquid crystal displays, and its demand is increasing steeply, also because of world wide spreading of the IT technology.

Of course, such a light transmission plate is required to have high optical properties as a material, however, there is also required very high dimension precision along the thickness direction (hereinafter, abbreviated as “plate thickness precision” in some cases) in comparison with conventional applications so that brilliance distribution in display is not formed.

On the other hand, there is a continuous casting method using a belt type continuous plate manufacturing apparatus, as a method of continuously producing a plate polymer. This belt type continuous plate manufacturing apparatus is an apparatus in which a polymerizable raw material is fed between facing belt surfaces of two endless belts placed at upper and lower positions and running at the same speed along the horizontal direction, from one end side of the belts, the polymerizable raw material is polymerized by a method such as heating together with movement of the endless belts, and the plate polymer is removed from another end side.

As a problem in plate thickness precision in such a continuous plate manufacturing apparatus, there is variation in plate thickness along the longitudinal direction of a plate product ascribable to irregular feeding of a raw material fed to the apparatus. Particularly, recently, high plate thickness precision is required, and even variation in flow rate which is so delicate that cannot be detected by a method such as installation of a flow meter in a raw material feeding line is regarded as a problem.

Therefore, for suppressing variation in plate thickness along the longitudinal direction, a necessity arises to provide a certain mechanism not in raw material feeding line but in a continuous plate manufacturing apparatus. As such a mechanism, there is mentioned an upper and lower roll pair placed so that respective axes thereof orthogonally cross the belt running direction between a raw material feeding position and a heating initiation position, as shown in, for example, Japanese Patent Application Publication (JP-B) No. 4-1685. However, this upper and lower pair is only described schematically in the general view of the belt type continuous plate manufacturing apparatus, and there is not clarified correlation at all with the plate thickness precision along the longitudinal direction.

Further, in the belt type continuous plate manufacturing apparatus, also a gasket and endless belts and the like, in addition to the above-mentioned upper and lower rolls, exert an extremely significant influence on the plate thickness precision of a plate product. For example, in endless belts, it is important to keep a belt surface to be contact with a raw material flat by some means. Particularly, in a heating zone, raw liquid and endless belts cause change in temperature accompanied by deformation due to thermal expansion, therefore, an attention is necessary for maintaining a belt surface under not-constant temperature condition.

As a method of maintaining a belt surface under not-constant temperature condition in a heating zone, there are, for example, a method in which the temperature of both side edge portions along the belt width direction is kept higher than that of the center portion in a zone in which polymerization of a polymerizable raw material in a heating zone progresses to un-flowable condition as shown in JP-B No. 58-49167, and other method. However, the present inventors retested according to this publication, a problem occurred that optical strain is caused along the belt running direction in the width direction of the resulted plate product in some cases. This optical strain was particularly remarkable at a temperature boundary position of a heating medium between both side edge portions of high temperature and the center portion of low temperature in the width direction. This optical strain does not satisfy extremely strict requirements of recent products, leaving a desire for quick improvement.

Further, a gasket is important not only for preventing leakage of a polymerizable raw material but also for enhancing the plate thickness precision of the resulted plate product. As a gasket suitable for a belt type continuous plate manufacturing apparatus, there is mentioned, for example, a gasket having a compression strength of 0.01 to 0.5 kg/cm when compressed to the intended plate thickness at the polymerization temperature as shown in JP-B No. 47-49823.

However, a level of plate thickness precision of ±0.3 mm set in producing a plate product having a thickness of 3 mm described in examples of this publication is often insufficient for applications recently required. According to investigation of the present inventors, it was found that even if a gasket satisfying the compression strength described in this publication is used, leakage of a raw material out of the gasket occurs in some cases. The reason for this leakage was hypothesized that distance between upper and lower belts in a heating zone varies between (T₁) immediately under upper and lower roll pairs provided for supporting belt surfaces and (T₂) between the roll pairs as shown in FIG. 6, accordingly, shift stress is applied periodically on the close-adhering part between the gasket and the belt surface.

However, even if the close adherence between the gasket and the belt surface is tried to be enhanced using a gasket having high compression strength as a means for preventing such leakage, only repulsion of the gasket of pushing the belt surface increases remarkably as compared with liquid pressure of liquid in a raw material of pushing the belt surface, resultantly, the thickness of both edge portions along the width direction of the resulted plate product increases extremely, in some cases.

### DISCLOSURE OF INVENTION

The present invention has been made to solve the above-mentioned problems in conventional technologies. Namely, an object of the present invention is to provide a belt type continuous plate manufacturing apparatus capable of producing a plate polymer having extremely high plate thickness precision, and a method of producing a plate polymer.

The present inventors have first investigated in detail variation in plate thickness along the longitudinal direction, and found that variation occurring in plate thickness is larger in the case of a belt type continuous plate manufacturing apparatus of larger width than in the case of an apparatus of smaller width. Further, the present inventors have intensely studied upper and lower roll pairs placed so that respective axes thereof orthogonally cross the belt running direction in a direction from a raw material feeding position to a heating initiation position, and resultantly found that variation in plate thickness along the longitudinal direction is significantly decreases when the outermost diameter of a roll body portion, the width of a roll body portion, and the distance between axis centers of adjacent roll pairs satisfy specific relations.

Also, the present inventors have investigated a way to keep the surface of an endless belt flat, and found that the reason for occurrence of optical strain along the belt running direction at the intermediate position between spray nozzles spraying mutually different heating media is that thermal expansion speed of both side edge portions is too larger than that of the center portion in the width direction of the endless belt to cause shift due to thermal deformation, leading to local irregularity. Then, the thermal expansion speed of an endless belt has been intensively investigated, and resultantly it has been found that if the speed of the temperature rising of an endless belt (hereinafter, abbreviated simply “temperature rising rate” in some cases) is set in a specific range, thermal deformation of an endless belt progresses substantially uniformly, and a plate polymer of extremely high plate thickness precision and having no optical strain along the width direction is obtained.

Further, the present inventors have found that the plate thickness precision of a plate polymer increases significantly when a specific gasket is used.

Namely, the present invention is a belt type continuous plate manufacturing apparatus comprising two endless belts so placed that their facing belt surfaces run toward the same direction at the same speed, and continuous gaskets running under condition of being sandwiched by belt surfaces at their both side edge portions, wherein a polymerizable raw material is fed into a space surrounded by the facing belt surfaces and the continuous gaskets from its one end, the polymerizable raw material is solidified together with running of the belts in a heating zone, and the plate polymer is taken out from the other end, characterized in that three or more upper and lower roll pairs satisfying the following formula (1) and formula (2) are placed so that respective axes thereof orthogonally cross the belt running direction, between a raw material feeding position and a heating initiation position:
D/Z≧0.04 (1)
0.30≦D/X≦0.99 (2)
D: outermost diameter of roll body portion [mm]
Z: width of roll body portion [mm]
X: distance between axis centers of adjacent upper and lower roll pairs [mm].

In the present invention, it is preferable that when the running two endless belts reach the inlet of the heating zone to show initiation of temperature rising, regulation is so made that the maximum value of temperature rising per minute is 60° C. or less in both of the two endless belts.

Further, in the present invention, it is preferable that a gasket is used so that the compression strength in compressing to the thickness of a plate polymer at the heating temperature is 0.5 N/mm or less and the contact width of the belt surface with the gasket outer surface in compressing to the thickness of a plate polymer at the heating temperature is 8 mm or more.

### BRIEF DESCRIPTION OF DRAWINGS

FIG. 1 is a schematic sectional view showing one example of the belt type continuous plate manufacturing apparatus of the present invention.

FIG. 2 is a schematic view of the upper and lower roll pairs 11, 11′ seen from the top side in FIG. 1.

FIG. 3 is a schematic view of the upper and lower roll pairs 11, 11′ seen from the side in FIG. 1.

FIG. 4 is a schematic view showing a condition of installation of a laser beam emitter 15 for detecting a position when a raw material spreading due to the self weight reaches a gasket at both side edge portions of a lower endless belt (gasket reach position) in a belt type continuous plate manufacturing apparatus.

FIG. 5 is an enlarged view of the contact part of an endless belt surface with a gasket outer surface in a section vertical to the belt running direction.

FIG. 6 is a schematic view showing a correlation of the distance between belt surfaces of upper and lower endless belts and upper and lower roll pairs seen from the side.

FIG. 7 is a schematic view showing optical strain evaluation in examples and comparative examples.

FIG. 8 is a perspective view showing plate size in evaluation in examples and comparative examples.

FIG. 9 is a perspective view showing plate size in evaluation in examples and comparative examples.

### BEST MODE FOR CARRYING OUT THE INVENTION

FIG. 1 is a schematic sectional view showing one example of the belt type continuous plate manufacturing apparatus of the present invention.

In the apparatus shown in this drawing, two endless belts (e.g., stainless belts) 1, 1′ are given tension by main pulleys 2, 3, 2′, 3′, and the lower belt 1′ is driven by the main pulley 3′. A liquid polymerizable raw material containing a polymerizable compound is fed by a metering pump 5, and fed from a nozzle 6 onto the surface of a lower belt. In this example, the end position of this nozzle 6 is a raw material feeding position.

The endless belts 1, 1′ have a width of preferably from 500 mm to 5000 mm, and a thickness of preferably from 0.1 mm to 3 mm. The tension applied on the endless belts 1, 1′ is preferably in the range of 1.0×10⁷ Pa to 1.5×10⁸ Pa per cross-sectional area vertical to the running direction. When the tension is too low, the belt is significantly deflected, undesirably. When the tension is too high, it is required to increase the rigidity of an apparatus more than the necessity, undesirably.

The endless belt 1 runs to the same direction at the same speed as that of the endless belt 1′ by frictional force via a gasket and plate polymer described later. The running speed is preferably from 0.1 m/min to 10 m/min, and can be appropriately changed depending on circumstances such as the thickness of a plate produced, timing of switching of articles, and the like.

Both side edge portions between belt surfaces are preferably sealed with a gasket 7 having a compression strength of 0.5 N/mm or less when compressed to the thickness of a plate polymer at the heating temperature. It is preferable that the gasket 7 is fed from a bobbin 13 situated further upstream of the continuous plate manufacturing apparatus and a gasket edge portion 14 is exposed to outside from the bobbin 13.

As the material of the gasket, soft polyvinyl chloride conventionally used is preferable since it can be any elastic modulus by changing the proportion of a plasticizer to be mixed. As the plasticizer to be mixed with polyvinyl chloride, there can be used dibutyl phthalate and di-2-ethylhexyl phthalate, and other compounds generally used in polyvinyl chloride. For example, when dibutyl phthalate or di-2-ethylhexyl phthalate is used as the plasticizer, it is preferable to mix it in a proportion of 20 to 60 parts by weight based on 100 parts by weight of polyvinyl chloride for producing a gasket having preferable compression strength in the present invention. In addition, thermostabilizers, antioxidants and the like can also be mixed appropriately.

Exemplified as the preferable material for a gasket, other than soft polyvinyl chloride, are foamed bodies of polyethylene, and other plastics having plasticity. These can give any elastic modulus by regulating forming magnification in molding them. Further, conventionally generally used rubbers such as natural rubber and other rubbers can also be used since elastic modulus can be regulated by changing the degree of vulcanization.

As the outer shape of a gasket, various forms such as circular, elliptic, rectangle and square are mentioned. In the case of rectangle, square or the like, strain at corner, in addition to deflection at smooth portions, affects compression strength, therefore, gaskets in the circular or elliptic form are preferable to manifest uniform compression strength. Regarding the structure thereof, it is preferable to have a hollow structure in which the section has inside a hollow part.

Regarding the size of a gasket, the peripheral length at the peripheral part of the section is preferably 20 mm or more, more preferably 30 mm or more. It is preferable that the contact width of a belt surface and a gasket outer surface when compressed to the thickness of a plate polymer at heating temperature is 8 mm or more. For regulating the contact width to 8 mm or more, the peripheral length at the peripheral part of the section should necessarily be larger than the value K represented by the following formula (4), and it is preferable to set the peripheral length larger by 2 mm or more than the value K.
K [mm]=2×(intended plate thickness [mm])+16 (4)

When the peripheral length at the peripheral part of the gasket section is over 400 mm, the use amount of a gasket per product necessarily increases, being undesirable from the standpoint of production cost.

In the case of a gasket having a hollow structure, the wall thickness thereof is preferably in the range from 0.1 mm to 4 mm. When air or inert gas is blown into a hollow portion, it is preferable to set the wall thickness thereof to 45% or less of the thickness of a plate polymer for securing an air duct of the hollow portion, and it is preferable to set it so that the sectional area of the hollow portion when compressed to the thickness of a plate polymer is at least 1 mm² or more.

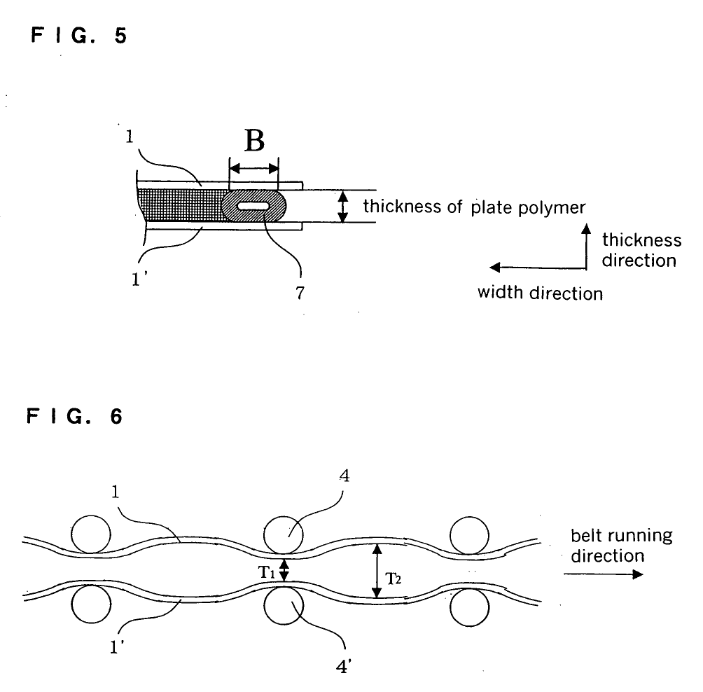

Regarding the size of the section of a gasket, it is preferable that the compression strength when compressed to the thickness of a plate polymer at heating temperature, namely, to the thickness of the intended product at heating temperature is 0.5 N/mm or less, and the contact width B of the outer surface of a gasket and the surface of a belt as shown in FIG. 5 when compressed to the thickness of a plate polymer at heating temperature is 8 mm or more. When the compression strength it too small, the form of a section cannot be maintained, and it becomes difficult to stably feed a gasket to a plate manufacturing apparatus, undesirably. When the contact width B is too narrow, the frequency of leakage of raw material liquid out of a gasket increases, and the repulsion of a gasket acts on the belt surface in a narrow range along the width direction to increase the plate thickness, undesirably. When the contact width is over 150 mm, the proportion of a product occupying the limited endless belt width is remarkably decreases, being undesirable from the standpoint of productivity.

When air or inert gas is blown into a hollow portion of a gasket having a hollow structure to give desired pressure, the apparent compression strength of a gasket can be arbitrarily regulated, therefore, a gasket of low elastic modulus having extremely small thickness can also be used.

It may also be permissible that the end portion of a gasket wound on a bobbin before fed to a plate manufacturing apparatus and a gas line are connected and air or inert gas is blown into this, or it may also be permissible that, in contrast, a gasket attached to the end portion of a plate after peeling from a continuous plate manufacturing apparatus and a gas line are connected and air or inert gas is blown into this, and the former case is preferable.

The pressure in a hollow portion of a gasket having a hollow structure is preferably regulated in the gauge pressure range of 0 to 3.0×10⁴ Pa. When the pressure in a hollow portion is too high, the repulsion of a gasket increases extremely larger than the inner liquid pressure of a raw material, inviting decrease in the plate thickness precision, undesirably. Additionally, expansion of a gasket becomes active, and the contact width of a belt surface and a gasket cannot be sufficiently secured, undesirably.

In mutually connecting gaskets having a hollow structure, it is preferable that the outer diameter of a gasket and the outer diameter of a connection part are not significantly different, and the connection part is not peeled in used. Further, when air or the like is blown into a hollow portion of a gasket, it is preferable that air or the like does not leak from the connection part.

As such a gasket connection method, the following methods are mentioned.

A method in which into hollow portions of two hollow gaskets α, β having a difference in their diameters of 0 to 2 mm, preferably from 0 to 1 mm, particularly preferably from 0 to 0.5 mm are inserted a hollow gasket γ of suitable length and having diameter smaller than the diameters of the gaskets α, β so as to connect the gaskets α, β, and the close adherence portion between the outer gaskets and the inner gasket (having smaller diameter) is adhered with an adhesive; a method in which the end surface of one of two hollow gaskets to be connected is elongated by pulling while heating by contact with a heat source such as steam and heater to make its diameter narrower, then, it is inserted into the end of another hollow gasket, and the close adherence portion between the outer gasket and the inner gasket is adhered with an adhesive; end surfaces of two hollow gaskets having a difference in their diameters of 0 to 2 mm, preferably from 0 to 1 mm, particularly preferably from 0 to 0.5 mm are heat-melted using a hot plate and the like and the peripheral parts of the hollow portions are allowed to contact and melt-adhered; and the like.

It is preferable that after mutual connecting of gaskets, burs at the connection part are cut by scissors, cutter knife and the like to make the surface of a gasket smooth. Further, it is also preferable that a plastic tape is wound on the connection part. Furthermore, it is preferable that a plastic tube of suitable length having a function of shrinking by heat is previously mounted before connection of hollow gaskets, and the gaskets are mutually connected, then, the connection part is covered with the plastic tube and allowed to contact with a heat source such as steam and heater to allow the plastic tube to shrink and contact closely to the hollow gaskets including the connection part, since then disadvantages such as leakage of air from deficiency of the connection part and the like can be prevented.

Further, it is also preferable that a plastic tube is wound on the boundaries of both ends of the shrunk plastic tube and the hollow gaskets.

A polymerizable raw material passes through a district in which upper and lower roll pairs 11, 11′ represented by black solid are placed, according to running of endless belts 1,1′, then, enters into a heating zone, and is solidified. In the present invention, a position in the heating zone, nearest to the raw material feeding side, is described as a heating initiation position. The heating zone has a heating means such as, hot water sprays 8, 8′. The temperature of the hot water sprays 8, 8′ is preferably in the range from 50° C. to 100° C.

In the present invention, it is preferable that in initiation of this temperature rising, regulation is so made that the maximum value of temperature rising per minute in both the upper and lower endless belts are 60° C. or less per minute. When the maximum value of temperature rising per minute is too high, thermal expansion of the endless belts progresses steeply, and delicate temperature irregularity along the below width direction causes shift of thermal deformation, leading to tendency of optical strain. Further, the maximum value of temperature rising in both the upper and lower endless belts is more preferably in the range from 10° C. to 58° C. per minute.

The method of regulating the temperature rising rate is not particularly restricted, and preferable is, for example, a method in which when upper and lower endless belts reach the inlet of a heating zone to show initiation of temperature rising, the temperature rising rate is regulated by allowing the belts to pass through a space maintained at a relative humidity of 50% or more and a temperature of 50° C. to 100° C. for at least 30 seconds after initiation of temperature rising.

More specifically, there is, for example, a method in which an initial heating zone 12 having an atmosphere temperature maintained at 50° C. to 100° C. is separately provided at the raw material feeding side than the heating zone by the hot water sprays 8, 8′ as shown in FIG. 1 and the temperature rising rate is regulated to desired value by heat conduction from atmosphere, or other method. The humidity in this initial heating zone 12 is maintained at 50% or more. By further increasing humidity, heat conduction by condensation of steam in atmosphere can be used easily, and regulation of the temperature rising rate of higher degree of freedom is made possible. However, it is not necessary to provide a wall vertical to the belt running direction to make a spatial clearance between the initial heating zone 12 and the subsequently positioned heating zone, and the initial heating zone 12 may have an open structure providing the temperature rising rate of the upper and lower endless belts 1, 1′ can be regulated in a desired range.

As other temperature rising rate regulating method, there are a method using hot air as a heating medium, and other methods.

When the initial heating zone 12 is not provided separately, there are listed, for example, methods in which the temperature of hot water is decreased at the inlet of the heating zone by the hot water sprays 8, 8′, the amount of hot water spray is decreased at the inlet, and the like.

After passing through the heating zone, a raw material is heat-treated by, for example, far infrared heaters 9, 9′ to complete polymerization thereof, and a product in the form of plate (i.e., plate polymer) 10 is taken out. The district of the far infrared heaters 9, 9′ is preferably controlled in the temperature range of 100° C. to 150° C. Further, other heating methods such as hot air may also be used in both of the hot water spray district and the far infrared heater district.

Next, the upper and lower roll pairs 11, 11′ placed between the raw material feeding position and the heating initiation position will be illustrated in detail. The distance along the belt running direction is represented by “length”, and the distance along the direction orthogonally crossing the belt running direction, namely, along the roll axis direction is represented by “width”.

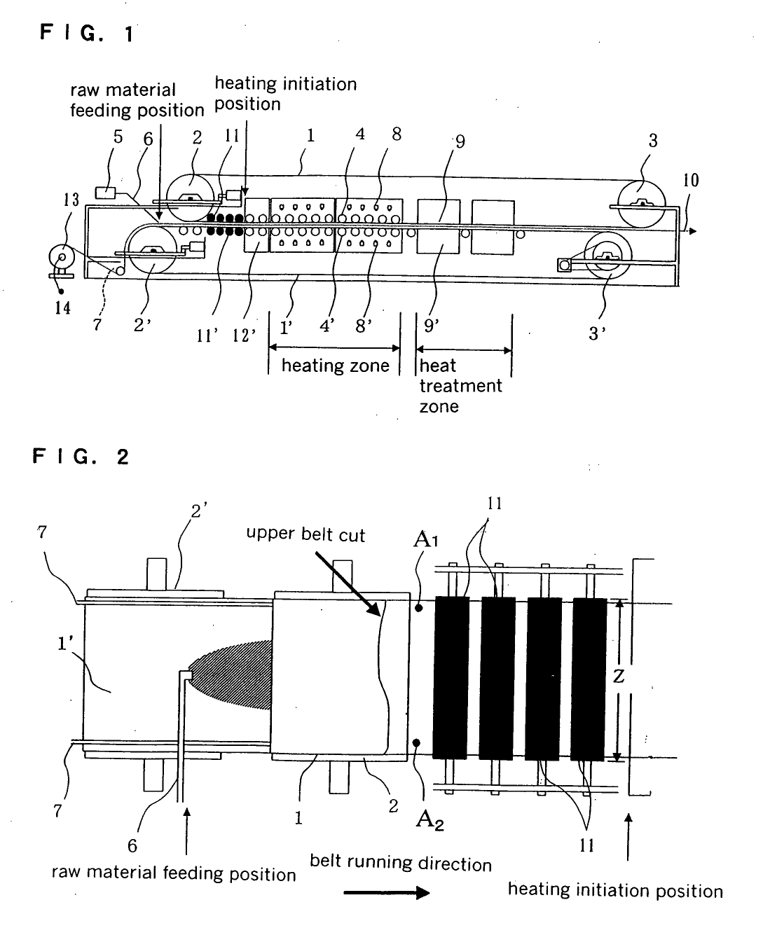

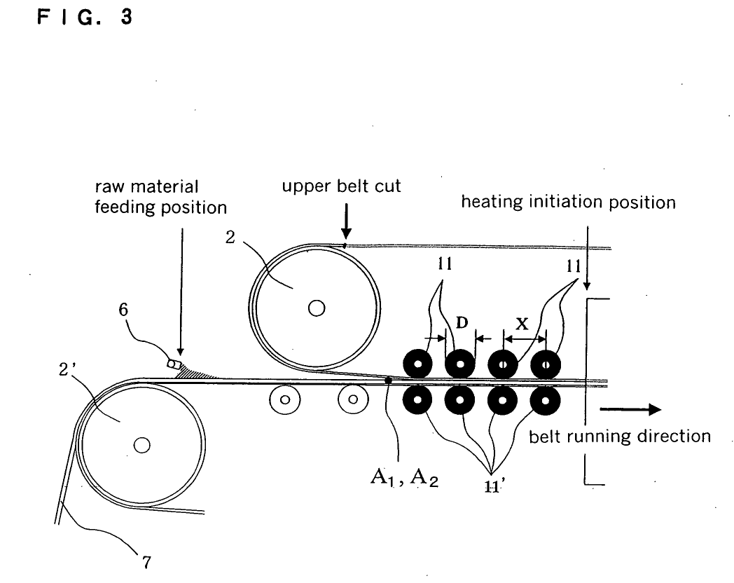

FIG. 2 is a schematic view of the upper and lower roll pairs 11, 11′ seen from the top side in FIG. 1. FIG. 3 is a schematic view of the upper and lower roll pairs 11, 11′ seen from the side. In both drawings, a part of the upper endless belt 1 is cut for easy watching of the upper and lower roll pairs.

As shown in FIG. 2 and FIG. 3, a raw material flows from a nozzle onto the surface of the lower belt, then, spreads by the self weight briefly along the width direction on the surface of the belt, and contact with gaskets 7 on both side edge portions at point A₁ and point A₂.

In FIG. 2 and FIG. 3, one nozzle 6 in the form of pipe is used as a raw material feeding part, however, the present invention is not limited to this embodiment. For example, nozzles of various forms such as die shape spreading along the width direction can be used, and one or a plurality of nozzles may be used. The position along the width direction of the nozzle 6 is also not particularly restricted, and preferable is a layout of symmetry from the center position along the width direction so that a raw material spreads uniformly along the width direction. Namely, the raw material feeding position preferably has a structure in which a raw material is flown from one or a plurality of pipes onto a plane surrounded by the lower endless belt and gaskets on both side edge portions.

In the present invention, the outermost diameter D [mm] of a roll body portion of upper and lower roll pairs 11, 11′, the width Z [mm] of a roll body portion and distance X [mm] between axis centers of adjacent roll pairs satisfy the following formula (1) and formula (2).
D/Z≧0.04 (1)
0.30≦D/X≦0.99 (2)

When the value of D/Z is less than 0.04, the rigidity of a roll along the width direction lowers, and when the feeding amount of a raw material varies, even if the variation is tried to be stabilized by diminishing clearance between upper and lower rolls, a roll body portion is rather deflected by the repulsion of a raw material and the variation is succeeded to the post process, and resultantly, the plate thickness of a product varies. The value of D/Z is preferably 0.3 or less. When the value of D/X is less than 0.30, even if the variation is tried to be stabilized by diminishing clearance between upper and lower rolls, a raw material enters between roll pairs, a flat property of upper and lower belt surfaces along the longitudinal direction decreases extremely, and a sufficient effect for stabilization of variation is not obtained. When the value of D/X is over 0.99, there is a crisis of mutual contact of upper and lower roll pairs adjacent along the longitudinal direction.

When at least one pair of the upper and lower roll pairs 11, 11′ satisfies the following formula (3), an extremely high effect of reducing vibration in plate thickness along the longitudinal direction.
0.50≦D/X≦50.99 (3)

Further, when the number of upper and lower roll pairs satisfying the formula (3) is two or more, a higher effect is obtained. The arrangement position of upper and lower roll pairs satisfying the formula (3) is not particularly restricted.

The outermost diameter D of a body portion of a roll used in the upper and lower roll pairs 11, 11′ is preferably from 60 mm to 500 mm. All of the upper and lower roll pairs 11, 11′ may have the same outermost diameter, and rolls having several different outermost diameters may be combined. The width Z of a roll body portion is preferably from 1000 mm to 5000 mm. The distance X between axis centers of adjacent roll pairs is preferably from 200 mm to 600 mm.

Regarding the material of a body portion of a roll, a roll body portion made of various metals such as stainless, iron and aluminum may be used, or a roll body portion made of a carbon-based complex material such as a carbon roll may be used. For the purpose of decreasing damage on the surface of a stainless belt by contact, the surface of a roll body portion may be coated with rubber. A structure may also be made so that the outermost diameter after coating with rubber is in the form of crown. However, when the thickness of rubber is increases, the diameter of a roll body portion becomes too large, leading to prevention of contact of a heating medium and a belt surface, and to increase in deflection amount by the self weight of a roll body portion. When these points are taken into consideration, the thickness of coating rubber is preferably from 1 mm to 20 mm. Regarding the precision of the size of a roll body portion, the Regarding the precision of the size of a roll body portion, the tolerance of the outermost diameter is preferably 0.1 mm or less.

In the present invention, the number of the upper and lower roll pairs 11, 11′ between the raw material feeding position and the heating initiation position is three or more. Particularly, this number is preferably 6 or more. Regarding the arrangement distance between adjacent upper and lower roll pairs 11, 11′, all of adjacent upper and lower roll pairs 11, 11′ may be placed at a constant interval along the belt running direction, or the distance may be partially changed. The upper and lower roll pairs 11, 11′ may be connected to individual separate frames capable of moving up and down, or a plurality of roll pairs may be connected by the same frame capable of moving up and down.

For the purpose of holding the lower belt surface at a position nearer to the raw material feeding position than the upper and lower roll pairs 11, 11′, one or plurality of rolls can be placed under the lower belt.

In this apparatus, a plurality of upper and lower roll pairs composed of an upper role in contact with the upper surface of the upper belt 1 and a lower roll in contact with the lower surface of the lower belt 1′ and having axes orthogonally crossing the belt running direction are placed along the belt running direction, as a mechanism of holding belt surfaces of endless belts running while facing. Both of the above-mentioned upper and lower roll pairs 11, 11′ and the plurality of upper and lower roll pairs 4, 4′ placed in the heating zone by the hot water sprays 8, 8′ correspond to the upper and lower roll pair as the above-mentioned belt surface holding mechanism. The suitable constitution of the upper and lower roll pairs 4, 4′ is the same as that of the above-mentioned upper and lower roll pairs 11, 11′.

Next, a method of detecting a point A₁ and appoint A₂ at which a raw material flowing from the nozzle 6 onto the surface of the lower belt and spreading by the self weight reaches gaskets on the both side edge portions of the lower belt (hereinafter, abbreviated as “gasket reaching position” in some cases), and a method of regulating this reaching point will be described below.

As shown in FIG. 3, the gasket reaching positions A₁ and A₂ are situated at position at which clearance between the upper belt and the lower belt is extremely small, it is difficult to correctly grasp this position by visual observation from circumferential positions and the like. The present inventors have, in the process of investigation, found a method of grasping the gasket reaching positions A₁ and A₂ extremely correctly and easily.

Namely, very effective is an apparatus constitution in which a laser beam emitter is provided on the raw material feeding part side and laser light is emitted from the laser beam emitter along the belt running direction. It is preferable that a position along the belt running direction at which a raw material spreading along the width direction by the self weight after feeding of the raw material from the raw material feeding position reaches gaskets on the both side edge portions on the lower endless belt is detected by, for example, emitting laser light along the belt running direction from the laser beam emitter and detecting reflection light orthogonally crossing the belt running direction among lights reflected at the gas-liquid interface between a raw material and air, and regulation is so made that this position shows a variation width of 1 m or less along the belt running direction. By this method, irregular feeding of a raw material fed to a continuous plate manufacturing apparatus which has conventionally been difficult to be detected can be indirectly grasped immediately and with extremely good precision, and the irregular feeding can be improved successfully. Smaller variation width is more preferable.

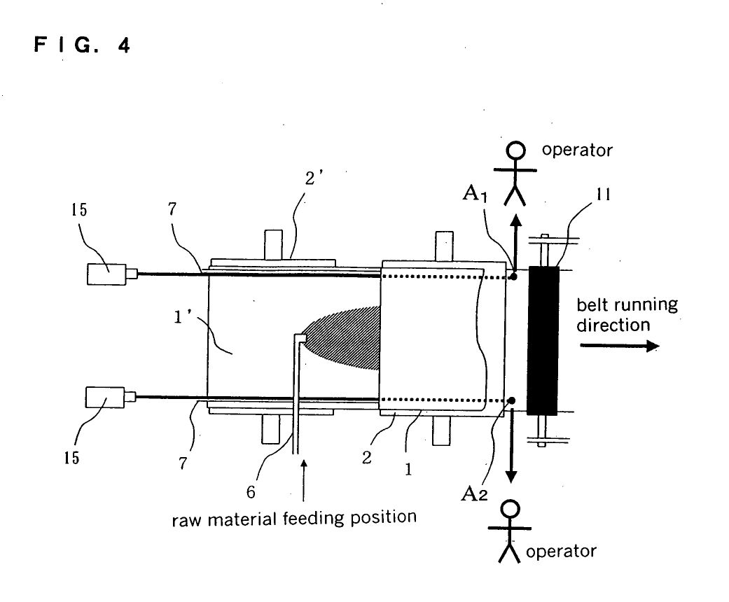

FIG. 4 is a schematic view showing a condition of installation of a laser beam emitter 15 for detecting the gasket reaching position, in a belt type continuous plate manufacturing apparatus.

In the laser beam emitter 15, the wavelength of laser light is not particularly restricted, and laser of He—Ne type or other desired laser can be used. The number of the laser beam emitters 15 is preferably two for grasping both of the gasket reaching positions A₁, A₂ on both sides. The emitting part of the laser beam emitters 15 is preferably regulated so that direction of light is substantially parallel to the running direction of the lower belt surface. The distance between laser light emitted from a light emitting part and a gasket is preferably from 1 to 300 mm. Emitted laser light progresses straight in parallel to the gasket, and is reflected to various directions at the gas-liquid interface of raw material liquid near the gasket reaching positions A₁, A₂. Of these reflection lights, reflection light vertical to the belt running direction can be easily confirmed visually by an operator situated at the side surface of a continuous plate manufacturing apparatus, and movement of the gasket reaching positions A₁, A₂ can be indirectly grasped with good precision.

When the feeding amount a raw material fed from the nozzle 6 varies, a position along the longitudinal direction of reflection laser light capable of being observed by an operator from the side surface of a continuous plate manufacturing apparatus changes, therefore, by regulating the distance between axes of upper and lower rolls of the upper and lower roll pairs 11, 11′, this change of the position can be easily amended.

It is not necessary that the laser beam emitter 15 is always in active condition in operation of a continuous plate manufacturing apparatus, and it is sufficient that the apparatus 15 is activated only in confirming the gasket reaching positions A₁, A₂.

A raw material of a plate polymer can be appropriately selected depending on the intended plate polymer. The continuous plate manufacturing apparatus of the present invention is suitable particularly for production of a methacrylic resin plate using methyl methacrylate as the main raw material. In producing a methacrylic resin plate, it is preferable to a polymerizable raw material containing methyl methacrylate in an amount of 50 wt % or more. Typically, single methyl methacrylate, or mixtures with other monomers copolymerizable with methyl methacrylate are listed. Further, a syrup obtained by dissolving a methyl methacrylate-based polymer in methyl methacrylate or a mixture thereof, and a syrup obtained by previously polymerizing a part of methyl methacrylate or a mixture thereof are also listed.

As the other copolymerizable monomers, listed are, for example, acrylates such as ethyl acrylate, n-butyl acrylate and 2-ethylhexyl acrylate; methacrylates other than methyl methacrylate such as ethyl methacrylate, n-butyl methacrylate and 2-ethylhexyl methacrylate; vinyl acetate, acrylonitrile, methacrylonitrile and styrene. In the case of a syrup, the polymer content is preferably regulated to 50 wt % or less in view of flowability of a polymerizable raw material.

To the polymerizable raw material, a chain transfer agent can also be added, if necessary. As the chain transfer agent, for example, primary, secondary or tertiary mercaptanes having an alkyl group or substituted alkyl group can be used. Specific examples thereof include n-butylmercaptane, i-butylmercaptane, n-octylmercaptane, n-dodecylmercaptane, s-butylmercaptane, s-dodecylmercaptane and t-butylmercaptane.

To the polymerizable raw material, a polymerization initiator is usually added. Specific examples thereof include organic peroxides such as tert-hexyl peroxypivalate, tert-hexyl peroxy-2-ethylhexanoate, di-isopropyl peroxydicarbonate, tert-butyl neodecanoate, tert-butyl peroxypivalate, lauroyl peroxide, benzyl peroxide, tert-butyl peroxyisopropylcarbonate, tert-butyl peroxybenzoate, dicumyl peroxide and di-tert-butyl peroxide; azo compounds such as 2,2′-azobis(2,4-dimethylvaleronitrile), 2,2′-azobis-isobutyronitrile, 1,1′-azobis(1-cyclohexanecarbonitrile) and 2,2′-azobis-(2,4,4-trimethylpentane).

In addition, various additives, for example, cross-linking agents, ultra-violet absorbers, light stabilizers, oxidation stabilizers, plasticizers, dyes, pigments, releasing agents, acrylic multi-layer rubbers can also be added to a raw material, if necessary. It is also possible to produce an artificial marble plate-shaped polymerized material by adding inorganic fillers to a polymerizable raw material.

A plate polymer produced by the present invention has a thickness preferably of about 0.3 to 20 mm.

The following examples will illustrate the present invention further in detail below, but do not limit the scope of the invention. “wt %” is abbreviated as “%”, and “parts by weight” is abbreviated as “parts”.

### EXAMPLE 1

To 100 parts of a methyl methacrylate syrup (viscosity: 1 Pa·s, 20° C.) having a degree of polymerization of 20% was added 0.1 part of tert-hexyl peroxypivalate (manufactured by NOF Corp., trade name: Perhexyl PV) as a polymerization initiator and 0.005 parts of sodium dioctylsulfosuccinate as a releasing agent and they were uniformly mixed, to obtain a liquid polymerizable raw material. This polymerizable raw material was de-foamed in a vacuum vessel, and applied to the apparatus in FIG. 1 to produce a plate product 1 having a thickness of 5 mm and a width of 1300 mm.

In this example, the apparatus in FIG. 1 has a total length of 10 m, two stainless endless belts 1, 1′ have a thickness of 1.5 mm and a width of 1.5 m, and both of them are given a tension of 3.0×10⁷ Pa by oil pressure. As the gasket 7, a gasket made of a polyvinyl chloride is mounted.

In a district from the raw material feeding position to the heating initiation position, four upper and lower roll pairs 11, 11′ in total are arranged at constant interval so that the arrangement distance X of the rolls is 200 mm. The body portion of each roll of the upper and lower roll pairs 11, 11′ is made of stainless having a hollow core section, and the outer part thereof is coated with rubber, further, stainless solid axes are provided on both ends of each roll. The outer diameter of the stainless body portion of each roll of the upper and lower roll pairs 11, 11′ is 70 mm, the outermost diameter D including the rubber part is 80 mm, the width Z is 1600 mm, the stainless wall thickness is 5 mm, the tolerance of the outermost diameter is 0.1 mm or less, namely, these rolls are a flat roll, the outer diameter of the solid axis is 30 mm, and the width of the solid axis is 125 mm. All of the upper and lower roll pairs 11, 11′ are regulated so that the distance between axes of upper and lower rolls is 90.0 mm. In these four of upper and lower roll pairs 11, 11′, D/Z=0.05, and D/X=0.40.

In upper and lower roll pairs 11, 11′, the axis of the upper roll 11 is supported via a bearing on a frame capable of moving up and down. The axis of the lower roll 11′ is supported via a bearing on a frame fixed to a foundation.

The heating zone has a length of 5 m, and has inside hot water sprays 8, 8′ of 76° C. In this heating zone, 12 stainless upper and lower roll pairs 4, 4′ in total having a surface coated with rubber and having an outermost diameter of 140 mm and a width of 1600 mm are arranged at the constant interval so that the arrangement distance of the roll pairs is 400 mm. After the heating zone by the hot water sprays 8, 8′, a district of 2 m for thermal treatment by far infrared heaters 9, 9′ is present.

The apparatus as described above was operated at a running speed of 130 mm/min of the endless belts 1, 1′, to produce a plate product 1 having a thickness of 5 mm and a width of 1300 mm.

### EXAMPLE 2

A plate product 2 was obtained in the same manner as in Example 1 excepting use of a roll pair composed of flat rolls having an outer diameter of a stainless body portion of 130 mm, an outermost diameter D including a rubber part of 150 mm, a width Z of 1600 mm, a stainless wall thickness of 5 mm, an outer diameter of a solid axis of 20 mm, a width of a solid axis of 125 mm and a tolerance of the outermost diameter of 0.1 mm or less, so regulated that the distance between axes of upper and lower rolls was 160.0 mm, as the second upper and lower roll pair from the raw material feeding position side among four upper and lower roll pairs 11, 11′ in a district from the raw material feeding position to the heating initiation position in the apparatus shown in FIG. 1. In this second upper and lower roll pairs 11, 11′ from the raw material feeding position side, D/Z=0.094, and D/X=0.75.

### EXAMPLE 3

A polymerizable raw material was de-foamed in a vacuum vessel, then, a plate product 3 having a thickness of 3 mm and a width of 2800 mm was produced by an apparatus as shown in FIG. 1 which is further larger than that in Example 1.

In the apparatus shown in FIG. 1 in this example, the total length is 100 m, and two stainless endless belts 1, 1′ have a thickness of 1.5 mm and a width of 3 m, and are given a tension of 8.0×10⁷ Pa by oil pressure. As the gasket 7, a gasket made of a polyvinyl chloride is mounted.

In a district from the raw material feeding position to the heating initiation position, eight upper and lower roll pairs 11, 11′ in total are arranged at constant interval so that the arrangement distance X of the rolls is 350 mm. The body portion of each roll of the upper and lower roll pairs 11, 11′ is made of stainless having a hollow core section, and the outer part thereof is coated with rubber, further, stainless solid axes are provided on both ends of each roll. The outer diameter of the stainless body portion of each roll of the upper and lower roll pairs 11, 11′ is 138 mm, the outermost diameter D including the rubber part is 160 mm, the width Z is 3100 mm, the stainless wall thickness is 5.7 mm, the tolerance of the outermost diameter is 0.1 mm or less, namely, these rolls are a flat roll, the outer diameter of the solid axis is 60 mm, and the width of the solid axis is 300 mm. All of the upper and lower roll pairs 11, 11′ are regulated so that the distance between axes of upper and lower rolls is 168.0 mm. In these eight of upper and lower roll pairs 11, 11′, D/Z=0.052, and D/X=0.46.

In upper and lower roll pairs 11, 11′, the axis of the upper roll 11 is supported via a bearing on a frame capable of moving up and down. The axis of the lower roll 11′ is supported via a bearing on a frame fixed to a foundation.

The heating zone has a length of 48 m, and has inside hot water sprays 8, 8′ of 80° C. In this heating zone, 120 stainless upper and lower roll pairs 4, 4′ in total having a surface coated with rubber and having an outermost diameter of 280 mm and a width of 3100 mm are arranged at the constant interval so that the arrangement distance of the roll pairs is 400 mm. After the heating zone by the hot water sprays 8, 8′, a district of 15 m for thermal treatment by far infrared heaters 9, 9′ is present.

The apparatus as described above was operated at a running speed of 2.3 m/min of the endless belts 1, 1′, to produce a plate product 3 having a thickness of 3 mm and a width of 2800 mm.

### COMPARATIVE EXAMPLE 1

A plate product 4 was obtained in the same manner as in Example 1 except that four flat rolls having an outer diameter of a stainless body portion of 47.6 mm, an outermost diameter D including a rubber part of 60 mm, a width Z of 1600 mm, a stainless wall thickness of 3.2 mm, an outer diameter of a solid axis of 20 mm, a width of a solid axis of 125 mm and a tolerance of the outermost diameter of 0.1 mm or less are arranged at the constant interval so that the distance between axes of upper and lower rolls was 160.0 mm, and the arrangement distance X of roll pairs was 150 mm. In these four upper and lower roll pairs 11, 11′, D/Z=0.038, and D/X=0.40.

### COMPARATIVE EXAMPLE 2

A plate product 5 was obtained in the same manner as in Example 1 except that the arrangement distance X of four roll pairs in total of the upper and lower roll pairs 11, 11′ in a district from the raw material feeding position to the heating initiation position was changed to a constant interval of 400 mm. In these four upper and lower roll pairs 11, 11′, D/Z=0.05, and D/X=0.20.

<Evaluation of Plate Thickness Precision>

The plate thickness precision of the products 1, 2 (Examples 1, 2) and the products 4, 5 (Comparative Examples 1, 2) were evaluated by the following method. First, as shown in FIG. 8, a plate product taken out continuously was cut every 1000 mm along the longitudinal direction, to obtain 50 plates of 1300 mm×1000 mm×5 mm. On all of these 50 plates, the thickness at the center point A in the width direction of the section and at points B1, B2 situated 100 mm inside from both ends were measured, and a difference between the largest value and the smaller value was used as plate thickness variation W.

In evaluation of plate thickness precision, when the absolute value of this plate thickness variation W is smaller, a flat property along the width direction is higher.

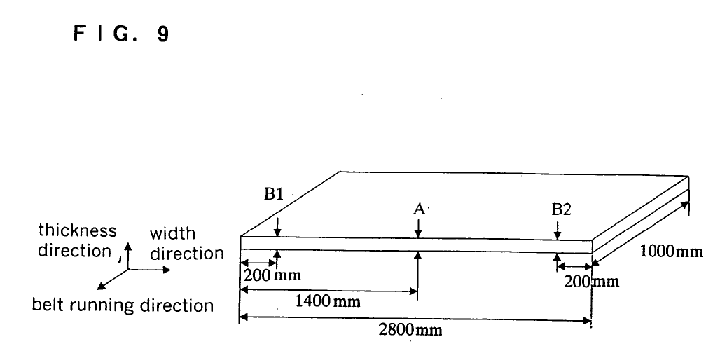

The plate thickness precision of the product 3 (Example 3) was evaluated in the same manner as described above except that the size of 50 plates was 2800 mm×1000 mm×3 mm and the points B1, B2 were situated 200 mm inside from both ends, as shown in FIG. 9.

The evaluation results are shown in Table 1.

TABLE 1

| No. of plate | Plate thickness variation [mm] | | |
|---|---|---|---|
| product | B1 | A | B2 |
| 1 | 0.062 | 0.080 | 0.054 |
| 2 | 0.044 | 0.048 | 0.037 |
| 3 | 0.058 | 0.071 | 0.046 |
| 4 | 0.134 | 0.151 | 0.110 |
| 5 | 0.117 | 0.140 | 0.115 |

### EXAMPLE 4

A plate product 6 was obtained in the same manner as in Example 1 except that the heating zone having a length of 5 m in the apparatus used in Example 1 was divided into a front half, initial heating zone 12 of a length of 0.5 m maintained at a temperature of 70° C. and a relative humidity of 70% and a latter half, heating zone 8 of a length of 4.5 m by hot water sprays 8, 8′ of 76° C. Here, the residence time of the initial heating zone 12 was 3.8 minutes. For grasping the temperature rising rate of the upper and lower endless belts, a thermocouple was pasted on the surfaces of the facing upper and lower belts from the raw material feeding position side and change in temperature was measured. As a result, the temperature rising rate during first 1 minute was 21° C./min on the upper belt and 22° C./min on the lower belt, and the subsequent temperature rising rates were further lower.

### EXAMPLE 5

A plate product 7 was obtained in the same manner as in Example 4 except that the initial heating zone 12 having a length of 0.5 m in the apparatus used in Example 4 was heated by a hot water spray using hot water of 85° C. The temperature rising rate during first 1 minute was 63° C./min on both the upper and lower belts, and the subsequent temperature rising rates were lower than 50° C./min.

<Evaluation of Optical Strain>

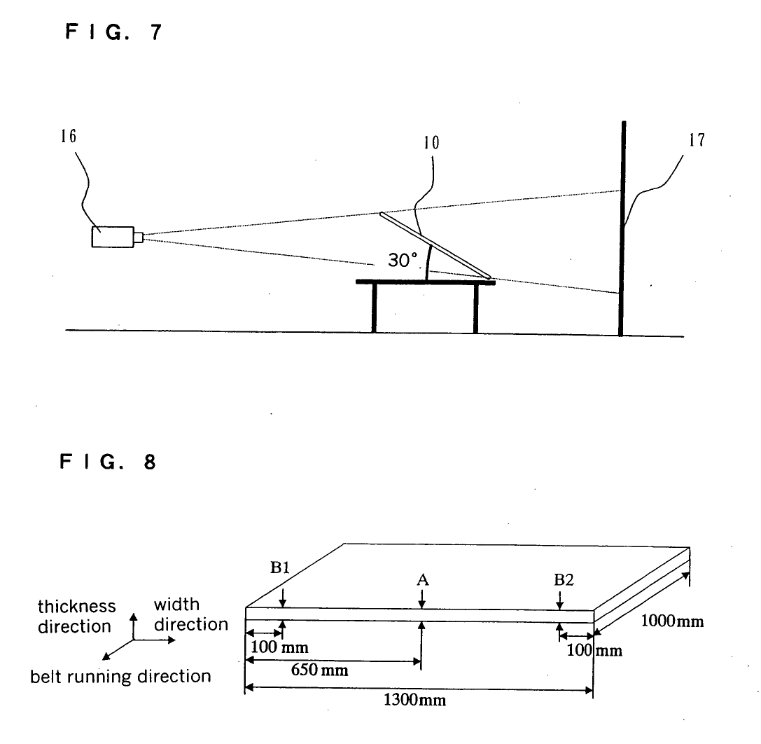

The optical strains of the products 6, 7 were evaluated by the following method. As shown in FIG. 7, plate product 6, 7 (10) was inclined at an angle of 30° from the ground so that sections vertical to the belt running direction constitute both side surfaces seen from a halogen lamp 16, light was emitted from the halogen lamp 16 to the acute angle side of the ground and the product plate, and an image projected on a projection screen 17 situated at the counter side from the plate product 6, 7 (10) was visually evaluated.

In optical strain evaluation, when black and white irregular concentration is not observed on the projected image, the product is judged to be a better plate showing no optical strain, and when white stripe or black and white irregular concentration patterns are observed, the product is judged to be a plate of worse quality showing optical strain.

The evaluation results are shown in Table 2 together with plate thickness variation.

TABLE 2

| No. of plate | Plate thickness variation [mm] | | | |
|---|---|---|---|---|
| product | B1 | A | B2 | Optical strain |
| 6 | 0.046 | 0.050 | 0.044 | Excellent with no |
| | | | | brilliance distribution |
| 7 | 0.061 | 0.076 | 0.066 | Slight brilliance |
| | | | | distribution and |
| | | | | white stripe |

### EXAMPLE 6

To 100 parts of polyvinyl chloride was uniformly mixed 45 parts by dibutyl phthalate (manufactured by Kyowa Hakko Kogyo Co., Ltd.) as a plasticizer, further, 10 parts of calcium carbonate (manufactured by Shiraishi Kogyo K.K.) as a carrier, 4 parts of epoxidized soy bean oil (manufactured by Dainippon Ink & Chemicals Inc., trade name: Eposizer W100EL) as a thermostabilizer, and 1 part of carboxylic acid metal salt, this mixture was thermally-molded to obtain a gasket 7 having an outer diameter of 16 mm and a wall thickness of 1.0 mm, and having circular outer shape and section of hollow structure. A plate product 8 having a thickness of 5 mm was obtained in the same manner as in Example 4 except that this gasket 7 was used. The compression strength when the gasket 7 was compressed to a thickness of 5 mm at 76° C. was 0.14 N/mm, and the contact width B of the gasket outer surface and the belt surface was 18 mm.

In this example, there was utterly no trouble of leakage of raw material liquid out of the gasket in continuous operation of 6 days.

### EXAMPLE 7

A plate product 9 having a thickness of 5 mm was obtained in the same manner as in Example 6 except that air was blown into both left and right hollow portions of the gasket 7 so that the gauge pressure was 4.0×10³ Pa.

In this example, there was utterly no trouble of leakage of raw material liquid out of the gasket in continuous operation of 6 days.

### EXAMPLE 8

A gasket 7 was produced in the same manner as in Example 6 except that the outer diameter was changed to 7 mm. A plate product 10 having a thickness of 5 mm was obtained in the same manner as in Example 4 except that this gasket 7 was used. The compression strength when the gasket 7 was compressed to a thickness of 5 mm at 76° C. was 0.16 N/mm, and the contact width B of the gasket outer surface and the belt surface was 5.5 mm.

In this example, there was observed twice a condition of leakage of a small amount of raw material liquid out of the gasket in continuous operation of 6 days.

### EXAMPLE 9

A gasket 7 was produced in the same manner as in Example 6 except that the amount of dibutyl phthalate was changed to 22 parts per 100 parts of polyvinyl chloride, and the wall thickness was changed to 1.1 mm. A plate product 11 having a thickness of 5 mm was obtained in the same manner as in Example 4 except that this gasket 7 was used. The compression strength when the gasket 7 was compressed to a thickness of 5 mm at 76° C. was 0.7 N/mm, and the contact width B of the gasket outer surface and the belt surface was 17.6 mm.

In this example, there was utterly no trouble of leakage of raw material liquid out of the gasket in continuous operation of 6 days.

### EXAMPLE 10

A plate product 12 was obtained in the same manner as in Example 7 except that two laser beam emitters 15 (manufactured by Riken Shokai K.K., type number: NAL-6FL) were set at a position opposite to the belt running direction from the main pulley 2′. In continuous operation of 6 days, the distance between axes of upper and lower rolls was appropriately regulated in the range from 89.7 to 90.3 mm so that the variation width of the position of laser reflection light seen from the position of an operator shown in FIG. 4 was 1 m or less. In regulation, all of the upper and lower roll pairs 11, 11′ got the same distance between axes of upper and lower rolls.

The results of evaluation of these plate thickness variation and optical strain are shown in Table 3.

TABLE 3

| No. of plate | Plate thickness variation [mm] | | | |
|---|---|---|---|---|
| product | B1 | A | B2 | Optical strain |
| 8 | 0.037 | 0.042 | 0.038 | Excellent with |
| | | | | no brilliance |
| | | | | distribution |
| 9 | 0.031 | 0.037 | 0.030 | Excellent with |
| | | | | no brilliance |
| | | | | distribution |
| 10 | 0.060 | 0.042 | 0.058 | Excellent with |
| | | | | no brilliance |
| | | | | distribution |
| 11 | 0.069 | 0.051 | 0.070 | Excellent with |
| | | | | no brilliance |
| | | | | distribution |
| 12 | 0.021 | 0.027 | 0.022 | Excellent with |
| | | | | no brilliance |
| | | | | distribution |

As apparent from the results shown in Table 1, the plate products 1 to 3 (Examples 1 to 3) had a flat property sufficient for light transmission plate application. Of them, the plate product 2 (Example 2) had extremely excellent plate thickness precision. On the other hand, when the plate products 6, 7 (Examples 4, 5) shown in Table 2 were compared, the plate product 6 (Example 4) showing a temperature rising rate during first 1 minute of the upper and lower belts in the initial heating zone of 21 to 22° C./min was superior to the plate product 7 (Example 5) showing a temperature rising rate of 63° C./min in both of the plate thickness precision and optical strain. When the plate products 8 to 12 (Examples 6 to 10) shown in Table 3 were compared, the plate products 8, 9, 12 (Examples 6, 7, 10) using gaskets having specific compression strength and contact width were superior to the plate products 10, 11 (Examples 8, 9) in a flat property. Of them, the plate product 9 (Example 7) obtained by blowing air into a hollow portion of a gasket had a fairly high flat property, and the plate product 12 (Example 10) obtained by blowing air into a hollow portion of a gasket and operating the apparatus so that the variation width of the position of laser reflection light was 1 m or less by mounting a laser beam emitter had an extremely high flat property. In contrast, the plate products 4, 5 (Comparative Examples 1, 2) had poor plate thickness precision, and were not sufficient for light transmission plate application.

1. A belt type continuous plate manufacturing apparatus comprising two endless belts so placed that their facing belt surfaces run toward the same direction at the same speed, and continuous gaskets running under condition of being sandwiched by belt surfaces at their both side edge portions, wherein a polymerizable raw material is fed into a space surrounded by the facing belt surfaces and the continuous gaskets from its one end, the polymerizable raw material is solidified together with running of the belts in a heating zone, and the plate polymer is taken out from the other end, characterized in that three or more upper and lower roll pairs satisfying the following formula (1) and formula (2) are placed so that respective axes thereof orthogonally cross the belt running direction, between a raw material feeding position and a heating initiation position:
D/Z≧0.04 (1)
0.30≦D/X≦0.99 (2)
D: outermost diameter of roll body portion [mm]
Z: width of roll body portion [mm]
X: distance between axis centers of adjacent upper and lower roll pairs [mm].

2. The belt type continuous plate manufacturing apparatus according to claim 1, wherein at least one of three or more upper and lower roll pairs satisfies the following formula (3):
0.50≦D/X≦0.99 (3)
D: outermost diameter of roll body portion [mm]
X: distance between axis centers of adjacent upper and lower roll pairs [mm].

3. The belt type continuous plate manufacturing apparatus according to claim 1, wherein the raw material feeding part has a structure in which a raw material is flown from one or a plurality of pipes onto a plane surrounded by the lower endless belt and the gaskets at the both side edge portions.

4. The belt type continuous plate manufacturing apparatus according to claim 1, wherein a laser beam emitter is provided on the side of the raw material feeding part and, laser ray is emitted from the laser beam emitter along the belt running direction.

5. A method of producing a plate polymer, wherein a plate polymer is obtained from a polymerizable raw material containing methyl methacrylate, using the belt type continuous plate manufacturing apparatus according to claim 1.

6. A method of producing a plate polymer, wherein a plate polymer is obtained from a polymerizable raw material containing methyl methacrylate, using the belt type continuous plate manufacturing apparatus according to claim 4.

7. The method of producing a plate polymer according to claim 5, wherein after feeding of a raw material from the raw material feeding part, a position on the belt running direction when a raw material spreading along the width direction due to the self weight reaches the gasket at the both side edge portions of the lower endless belt is detected, and regulation is so made that this position shows a variation width of 1 m or less along the belt running direction.

8. The method of producing a plate polymer according to claim 6, wherein after feeding of a raw material from the raw material feeding part, a position on the belt running direction when a raw material spreading along the width direction due to the self weight reaches the gasket at the both side edge portions of the lower endless belt is detected by emitting laser ray from the laser beam emitter along the belt running direction and detecting reflection light orthogonally crossing the belt running direction among lights reflected at the gas-liquid interface between a raw material and air, and regulation is so made that this position shows a variation width of 1 m or less along the belt running direction.

9. The method of producing a plate polymer according to claim 5, wherein when the running two endless belts reach the inlet of the heating zone to show initiation of temperature rising, regulation is so made that the maximum value of temperature rising per minute is 60° C. or less in both of the two endless belts.

10. The method of producing a plate polymer according to claim 9, wherein when the running two endless belts reach the inlet of the heating zone to show initiation of temperature rising, the belts pass through a space maintained at a relative humidity of 50% or more and a temperature of 50° C. to 100° C. for at least 30 seconds after initiation of temperature rising.

11. The method of producing a plate polymer according to claim 5, wherein a gasket is used so that the compression strength in compressing to the thickness of a plate polymer at the heating temperature is 0.5 N/mm or less and the contact width of the belt surface with the gasket outer surface in compressing to the thickness of a plate polymer at the heating temperature is 8 mm or more.

12. The method of producing a plate polymer according to claim 11, wherein the gasket has a hollow structure, and air or inert gas is blown into the hollow part of the gasket to regulate the pressure in the hollow part.

13. The method of producing a plate polymer according to claim 12, wherein the pressure in the hollow part of the gasket is regulated in the range of gauge pressures of 0 to 3.0×10⁴ Pa.
